(19) United States
(12) Patent Application Publication
(10) Pub. No.: US 2006/0123391 A1
(43) Pub. Date: Jun. 8, 2006

(54) Method for plug-in program management of a computer system

(76) Inventor: Lai-Chen Lai, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,623

(22) Filed: Jun. 21, 2005

(30) Foreign Application Priority Data
Dec. 8, 2004 (TW) 93137943

(51) Int. Cl. G06F 9/44

(52) U.S. Cl. 717/120

(57) ABSTRACT

A method for plug-in program management is provided, including the starting of a plug-in program after the computer is booted and finishes the initialization. The plug-in program automatically loads a plug-in management table, which is customized by the user to include the target programs. The user uses a mouse to select and drag a target program for plugging into a frame of another program to improve the efficiency of the workflow.

### FIELD OF THE INVENTION

The present invention relates to a method for plug-in programs and, more particularly, to a method for plug-in program management by using a mouse to select and drag a target program for plugging into a frame of another program.

### BACKGROUND OF THE INVENTION

As the software development progresses rapidly, the window-based personal computer (PC) software is widely used in offices, households and other business locations.

One of the most popular current PC software applications is word processing application. During the word processing, it is sometimes necessary to open up other plug-in programs, such as calculator, and calendar. In the case of opening a plug-in program during an application program, the application program usually opens a frame or a pop-up window to display the plug-in.

However, when an application programs opens up a second plug-in program, after the first plug-in program is in use, the frame used to display the first plug-in program is usually replaced with a frame displaying the second plug-in program. This may cause much inconvenience, and reduces the efficiency of work. For example, when the user needs to use the first plug-in program, the user is required to click on the first plug-in to obtain a frame displaying the first plug-in program, and this time the frame displaying the second plug-in disappears from the screen. If the user needs to use two plug-in programs in an alternating fashion, the user must constantly clicking on both plug-in programs to display the frame.

### SUMMARY OF THE INVENTION

The present invention is provided to overcome the aforementioned drawback of the current technology. The primary object of the present invention is to provide a method for plug-in program management so that when using a word processing application with a plug-in program, the user can start a second plug-in program without the first plug-in program disappearing or blocked from the screen. The plug-in program is embedded in the word processing application, includes a memory and learning capability, and can automatically start and adjust the display size in accordance with the word processing application.

Another object of the present invention is to provide a customizable plug-in management table, including the fields of a plug-in frame number, location of the target plug-in program, foreground size of the target plug-in application, the path of target plug-in application, and so on. The user can customize the contents of the word processing application so that the word processing application is further customized.

To achieve the above objects, the present invention provides a method including the starting of a plug-in program of the present invention after the computer is booted and finishes the initialization. The plug-in program automatically loads a plug-in management table, which can be customized by the user to include the target programs, such as calculator and calendar.

After the plug-in management table is loaded, the computer detects whether the user selects to switch to a different frame. When the selection of the frame is detected, the computer activates and executes the target plug-in programs pointed by the program path according to the target program path corresponding to the plug-in frame number. At the same time, the computer will plug into the selected frame according to the location and foreground size of the target plug-in program corresponding to the plug-in frame number. The computer will also automatically adjust the location and the foreground size of the target plug-in program to achieve the plug-in program management method of the present invention.

In comparison to the conventional techniques, the present invention overcomes the problem of a target plug-in program disappearing from the screen when opening a second target plug-in program. In addition, the present invention provides a management method including a customizable plug-in management table. The plug-in management table includes the fields of a plug-in frame number, location of the target plug-in program, foreground size of the target plug-in application, and the path of target plug-in application. The path of target plug-in program points to a target plug-in program. The plug-in frame number, the location of the target plug-in program, the foreground size of the target plug-in program, and the path of the target plug-in program can all be customized to meet individual user's convenience.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a block diagram of a plug-in management method of the present invention;

FIG. 2 shows a control flowchart of a first embodiment of the present invention;

FIG. 3 shows a control flowchart of a second embodiment of the present invention; and

FIG. 4 shows a schematic view of the plug-in management table of the present invention.

### DETAILED DESCRIPTION OF PREFERRED EMBODIMENT

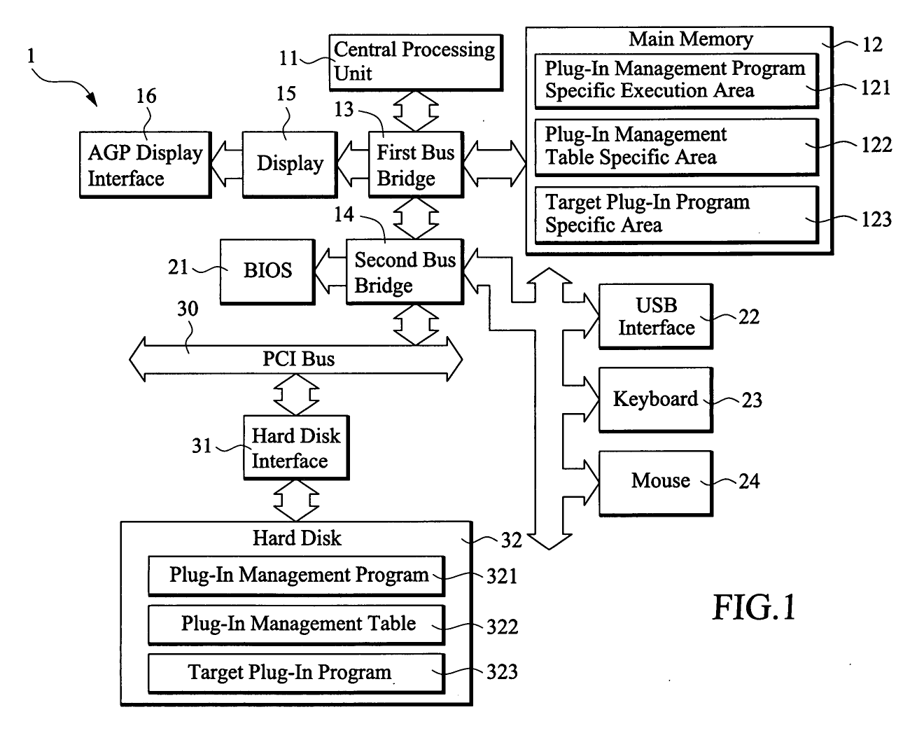

With reference to the drawings and in particular to FIG. 1, which shows a block diagram of a plug-in program management method of the present invention, a computer 1 includes a central processing unit (CPU) 11, a main memory 12, a first bus bridge 13, and a second bus bridge 14. The first bus bridge 13 and the second bus bridge 14 constitute a computer main structure through the internal system bus of the computer.

The first bus bridge 13, which is also referred to as “north bridge”, is connected to an AGP display interface 16 and a display 15.

The main memory 12 stores a plug-in management program specific execution area 121, a plug-in management table specific area 122, and a target plug-in program specific area 123.

The second bus bridge 14, which is also referred to as “south bridge”, is connected to a BIOS 21, a USB interface 22, a keyboard 23, a mouse 24, and a PCI bus 30. The PCI bus 30 is connected to a hard disk interface 31, and a hard disk 32. The hard disk 32 stores a plug-in management program 321, a plug-in management table 322, and a target plug-in program 323.

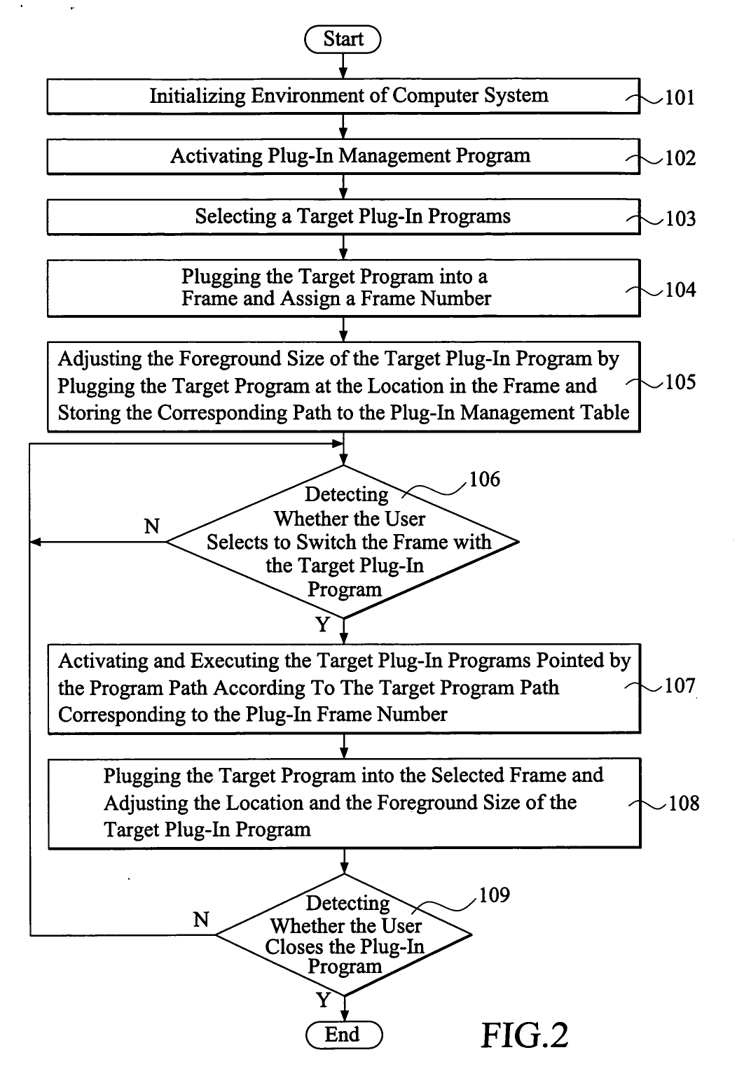

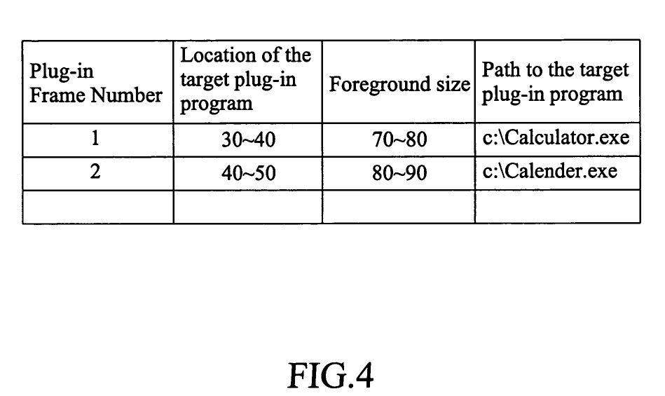

Also referring to FIG. 2, which shows a control flowchart of a first embodiment of the present invention, the following description also refers to the plug-in management table shown in FIG. 4.

When the computer is powered on, the operating system completes the initialization of the environment (step 101), and enters the user operation mode. The user can activate the plug-in management program (step 102) and start to build the plug-in management table.

The plug-in management table of FIG. 4 contains two records of short-cut information, including: (1) in the first record, the plug-in frame number is 1, the location of the target plug-in program is 30-40 (30 mm in y-axis and 40 mm in x-axis), the foreground size is 70-80 (70 mm long and 80 mm wide), and the path to the target plug-in program is C:\Calculator.exe; and (2) in the second record, the plug-in frame number is 2, the location of the target plug-in program is 40-50 (40 mm in y-axis and 50 mm in x-axis), the foreground size is 80-90 (80 mm long and 90 mm wide), and the path to the target plug-in program is C:\Calendar.exe.

The plug-in frame number of the plug-in management table is the serial number of the target plug-in program with a plurality of frames.

The building of the plug-in management table includes several preparation steps. One of the preparation steps is selecting the target plug-in programs (step 103), and the second preparation step is to plug the target program into any frame and assign a frame number (step 104). The third step is to adjust the foreground size of the target plug-in program by plugging the target program at the location in the frame and storing the corresponding path to the plug-in management table (step 105).

After the preparation steps, the computer will detects whether the user selects to switch the frame with the target plug-in program (step 106). If so, the computer activates and executes the target plug-in programs pointed by the program path according to the target program path corresponding to the plug-in frame number (step 107). In step 108, the computer will plug the target program into the selected frame according to the location and foreground size of the target plug-in program corresponding to the plug-in frame number. The computer will also automatically adjust the location and the foreground size of the target plug-in program to achieve the plug-in program management method of the present invention.

Then, the computer will detects whether the user closes the plug-in program (step 109). If so, the computer terminates the plug-in program; otherwise, the process returns to step 106 for detecting the selection to switch.

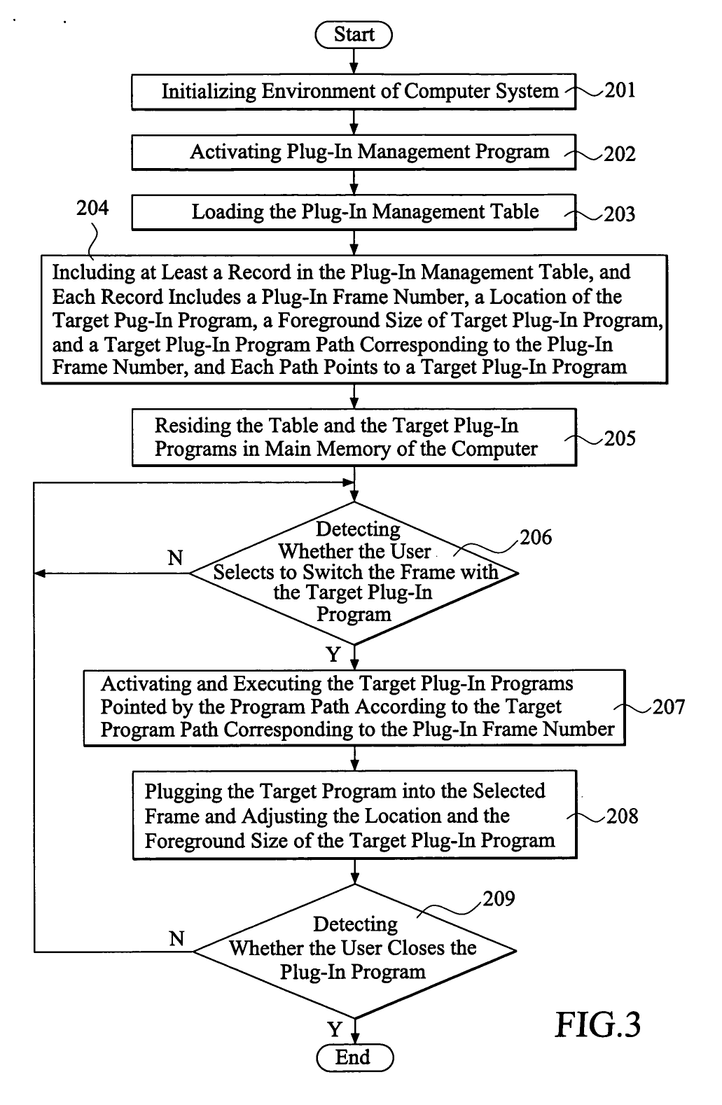

FIG. 3 shows a control flowchart of a second embodiment of the present invention. When the computer is powered on, the operating system completes the initialization of the environment (step 201), and enters the user operation mode. The user can activate the plug-in management program (step 202) and the program loads the plug-in management table built earlier (step 203). The plug-in management table at least includes a record, and each record includes a plug-in frame number, a location of the target pug-in program, a foreground size of target plug-in program, and a target plug-in program path corresponding to the plug-in frame number. Each path points to a target plug-in program (step 204).

After loading the plug-in management table, the table and the target plug-in programs will reside in the main memory of the computer (step 205).

Then, the computer detects whether the user selects to switch the frame with the target plug-in program (step 206). If so, the computer activates and executes the target plug-in programs pointed by the program path according to the target program path corresponding to the plug-in frame number (step 207). In step 208, the computer will plug into the selected frame according to the location and foreground size of the target plug-in program corresponding to the plug-in frame number. The computer will also automatically adjust the location and the foreground size of the target plug-in program to achieve the plug-in program management method of the present invention.

Then, the computer will detects whether the user closes the plug-in program (step 209). If so, the computer terminates the plug-in program; otherwise, the process returns to step 106 for detecting the selection to switch.

While the invention has been described in connection with what is presently considered the best mode for carrying out the present invention, it is to be understood that the invention is not to be limited to what is disclosed above, but on the contrary, is intended to cover various modifications and equivalent arrangement included within the spirit and scope of the appended claims.

What is claimed is:

1. A method for managing plug-in programs of a computer system, comprising the steps of:
(a) an operating system initializing the operating environment of the computer system;
(b) building an plug-in management table, the plug-in management table comprising at least a record of plug-in management information, each record of plug-in management information comprising a plug-in frame number, a location of target plug-in program, a foreground size of a target plug-in program, and a target path corresponding to the plug-in frame number, each target path pointing to a target plug-in program;
(c) detecting whether a user selecting to switch to a frame with a target plug-in program; and
(d) activating target plug-in program pointed by the target path corresponding to the plug-in frame number.

2. The method as claimed in claim 1, wherein step (b) further comprises the steps of:
(b1) selecting a target plug-in program;
(b2) embedding the target plug-in program to a frame and assigning a frame number;
(b3) adjusting foreground size and location of the target plug-in program in the frame; and
(b4) storing the plug-in frame number, the target path corresponding to the frame number into the plug-in management table.

3. The method as claimed in claim 1, wherein the plug-in management table and the target plug-in program reside in a main memory of the computer after step (b).

4. The method as claimed in claim 1, wherein the target plug-in program is plugged into the frame by using a mouse to click and drag the target plug-in program.

5. The method as claimed in claim 1, wherein the target plug-in program is plugged into the selected frame according to the target path, the foreground size of the target plug-in program corresponding to the frame number after step (d).

6. The method as claimed in claim 5 further comprising a step of automatic adjustment of the location and the foreground size of the target plug-in program.

7. A method for managing plug-in programs of a computer system, comprising the steps of:
(a) an operating system initializing the operating environment of the computer system;
(b) loading an plug-in management table into a main memory of the computer, the plug-in management table comprising at least a record of plug-in management information, each record of plug-in management information comprising a plug-in frame number, a location of target plug-in program, a foreground size of a target plug-in program, and a target path corresponding to the plug-in frame number, each target path pointing to a target plug-in program;
(c) detecting whether a user selecting to switch to a frame with a target plug-in program; and
(d) activating target plug-in program pointed by the target path corresponding to the plug-in frame number.

8. The method as claimed in claim 7, wherein the plug-in management table and the target plug-in program reside in the main memory of the computer after step (b).

9. The method as claimed in claim 7, wherein the target plug-in program is plugged into the frame by using a mouse to click and drag the target plug-in program.

10. The method as claimed in claim 7, wherein the target plug-in program is plugged into the selected frame according to the target path, the foreground size of the target plug-in program corresponding to the frame number after step (d).

11. The method as claimed in claim 10 further comprising a step of automatic adjustment of the location and the foreground size of the target plug-in program.
